(19) United States
(12) Patent Application Publication
(10) Pub. No.: US 2024/0370265 A1
(43) Pub. Date: Nov. 7, 2024

(54) BRANCH INSTRUCTION PROCESSING METHOD, SYSTEM, AND DEVICE, AND COMPUTER STORAGE MEDIUM

(71) Applicant: INSPUR SUZHOU INTELLIGENT TECHNOLOGY CO., LTD., Suzhou, Jiangsu (CN)

(72) Inventors: Zhenlei ZHANG, Suzhou, Jiangsu (CN); Tuo LI, Suzhou, Jiangsu (CN); Hongtao MAN, Suzhou, Jiangsu (CN); Tongqiang LIU, Suzhou, Jiangsu (CN); Yulong ZHOU, Suzhou, Jiangsu (CN); Xiaofeng ZOU, Suzhou, Jiangsu (CN); Xiankun WANG, Suzhou, Jiangsu (CN)

(21) Appl. No.: 18/563,862

(22) PCT Filed: Jun. 22, 2022
(86) PCT No.: PCT/CN2022/100476

§ 371 Date: Nov. 22, 2023

(30) Foreign Application Priority Data
Dec. 3, 2021 (CN) 202111461357.6

(51) Int. Cl. G06F 9/38; G06F 9/30

(52) U.S. Cl. CPC G06F 9/3804; G06F 9/30058

(57) ABSTRACT

The present application discloses a branch instruction processing method, system, and device, and a computer storage medium. The method includes: determining, on the basis of a target branch instruction, a branch instruction to be predicted (S101); predicting, on the basis of a plurality of preset branch prediction methods, the branch instruction to be predicted, so as to obtain a corresponding prediction result (S102); determining the prediction accuracy of each branch prediction method on the basis of the prediction result (S103); determining the branch prediction method corresponding to the highest prediction accuracy as a target branch prediction method (S104); and performing branch prediction on the target branch instruction on the basis of the target branch prediction method (S105).

### CROSS-REFERENCE TO RELATED APPLICATION

The present application claims priority of Chinese patent application filed on Dec. 3, 2021 before the China National Intellectual Property Administration with the application number of 202111461357.6, and the title of “BRANCH INSTRUCTIONPROCESSING METHOD. SYSTEM. DEVICE AND COMPUTER STORAGE MEDIUM”, which is incorporated herein in its entirety by reference.

### FIELD

The present application relates to the technical field of computer and more particularly, to a branch instruction processing method, system, device and computer storage medium.

### BACKGROUND

The inventor realizes that, at present, when a processor is processing a branch instruction, it may jump, so that the processing of pipeline instructions is interrupted until the execution of the branch instruction is completed. The longer the pipeline, the longer the waiting time of the processor. In order to avoid this situation, the processor needs to perform branch prediction, that is, the processor predicts whether to execute the branch instruction before executing the branch instruction, for example, estimating whether to jump to execute the branch instruction at present according to whether to jump to execute the branch instruction last time. However, the accuracy of existing branch prediction is poor, and the failure of the branch prediction will cause the processor to lose about 20 clock cycles and affect the performance of the processor.

### SUMMARY

The present application provides a branch instruction processing method, including:
determining a branch instruction to be predicted based on a target branch instruction;
predicting the branch instruction to be predicted based on a plurality of branch prediction methods which are preset, to obtain corresponding prediction results;
determining prediction accuracy of each of the plurality of branch prediction methods based on the prediction result;
determining the branch prediction method corresponding to the prediction accuracy with the highest value as a target branch prediction method; and
performing branch prediction on the target branch instruction based on the target branch prediction method.

In one of the embodiments, the branch prediction method includes a method for always predicting a jump execution branch instruction.

In one of the embodiments, the branch prediction method includes a method for always predicting a non-jump execution branch instruction.

In one of the embodiments, the branch prediction method includes a method for determining a current branch prediction result based on a branch prediction state.

In one of the embodiments, the branch prediction method includes:
when the branch prediction state is a non-jump execution branch instruction of a first-level, the current branch prediction result is not jump; when current branch prediction is verified to be successful, keeping the branch prediction state to be the non-jump execution branch instruction of the first-level; and when the current branch prediction is verified to be failed, adjusting the branch prediction state to be the non-jump execution branch instruction of a second-level;
when the branch prediction state is the non-jump execution branch instruction of the second-level, the current branch prediction result is not jump; and when the current branch prediction is verified to be successful, adjusting the branch prediction state to be the non-jump execution branch instruction of the first-level; and when the current branch prediction is verified to be failed, adjusting the branch prediction state to be a jump execution branch instruction of the second-level;
when the branch prediction state is the jump execution branch instruction of the second-level, the current branch prediction result is jump, when the current branch prediction is verified to be successful, adjusting the branch prediction state to be the jump execution branch instruction of the first-level, and when the current branch prediction is verified to be failed, adjusting the branch prediction state to be the non-jump execution branch instruction of the second-level; and
when the branch prediction state is the jump execution branch instruction of the first-level, the current branch prediction result is jump, when the current branch prediction is verified to be successful, keeping the branch prediction state to be the jump execution branch instruction of the first-level, and when the current branch prediction is verified to be failed, adjusting the current branch prediction state to be the jump execution branch instruction of the second-level;
among them, an execution probability of the first level is greater than an execution probability of the second level.

In one of the embodiments, the branch prediction method includes:
when a cumulative number of prediction results for the branch prediction state representing a jump execution branch instruction is 1, the current branch prediction result is jump. and when the current branch prediction is verified to be successful, adjusting the cumulative number of the prediction results for the branch prediction state representing the jump execution branch instruction to be 2; and when the current branch prediction is verified to be failed, keeping the cumulative number of the prediction results for the branch prediction state representing the jump execution branch instruction to be 1;
when the cumulative number of the prediction results for the branch prediction state representing the jump execution branch instruction is 2, the current branch prediction result is jump; when the current branch prediction is verified to be successful, adjusting the cumulative number of the prediction results for the branch prediction state representing the jump execution branch instruction to be 3; and when the current branch prediction is verified to be failed, adjusting the cumulative number of the prediction results for the branch prediction state representing the jump execution branch instruction to be 1;
when the cumulative number of the prediction results for the branch prediction state representing the jump execution branch instruction is 3, the current branch prediction result is jump; when the current branch prediction is verified to be successful, adjusting the branch prediction state representing a non-jump execution branch instruction; and when the current branch prediction is verified to be failed, adjusting the cumulative number of the prediction results for the branch prediction state representing the jump execution branch instruction to be 1; and
when the branch prediction state representing the non-jump execution branch instruction. the current branch prediction result is not jump; when the current branch prediction is verified to be successful, adjusting the cumulative number of the prediction results for the branch prediction state representing the jump execution branch instruction to be 1; and when the current branch prediction is verified to be failed, keeping the branch prediction state to represent the non-jump execution branch instruction.

In one of the embodiments, the branch prediction method includes:
when a cumulative number of prediction results for the branch prediction state representing a non-jump execution branch instruction is 1, a current branch prediction result is not jump; when a current branch prediction is verified to be successful, adjusting the cumulative number of the prediction results for the branch prediction state representing the non-jump execution branch instruction to be 2; and when the current branch prediction is verified to be failed. keeping the cumulative number of the prediction results for the branch prediction state representing the non-jump execution branch instruction to be 1;
when the cumulative number of the prediction results for the branch prediction state representing the non-jump execution branch instruction is 2, the current branch prediction result is not jump; when the current branch prediction is verified to be successful, adjusting the cumulative number of the prediction results for the branch prediction state representing the non-jump execution branch instruction to be 3; and when the current branch prediction is verified to be failed, adjusting the cumulative number of the prediction results for the branch prediction state representing the non-jump execution branch instruction to be 1;
when the cumulative number of the prediction results for the branch prediction state representing the non-jump execution branch instruction is 3, the current branch prediction result is not jump; when the current branch prediction is verified to be successful, adjusting the branch prediction state to represent a jump execution branch instruction; and when the current branch prediction is verified to be failed, adjusting the cumulative number of the prediction results for the branch prediction state representing the non-jump execution branch instruction to be 1; and
when the branch prediction state representing the jump execution branch instruction, the current branch prediction result is jump; when the current branch prediction is verified to be failed, keeping the branch prediction state to represent the jump execution branch instruction; and when the current branch prediction is verified to be successful, adjusting the cumulative number of the prediction results for the branch prediction state representing the non-jump execution branch instruction to be 1.

A branch instruction processing system, including:
a first determination module, configured for determining a branch instruction to be predicted based on a target branch instruction;
a first prediction module, configured for predicting the branch instruction to be predicted based on a plurality of branch prediction methods which are preset, to obtain corresponding prediction results;
a second determination module, configured for determining prediction accuracy of each of the plurality of branch prediction methods based on the prediction result;
a third determination module, configured for determining the branch prediction method corresponding to the prediction accuracy with the highest value as a target branch prediction method; and
a second prediction module, configured for performing branch prediction on the target branch instruction based on the target branch prediction method.

A branch instruction processing device, including a memory and one or more processors, among them, a computer-readable instruction is stored in the memory, and when executed by the one or more processors, the computer-readable instruction makes the one or more processors execute the steps of the branch instruction processing methods above-mentioned.

One or more non-transitory computer-readable storage media storing a computer-readable instruction, among them the computer-readable instruction, when executed by one or more processors, makes the one or more processors execute the steps of the branch instruction processing methods above-mentioned.

Details of one or more embodiments of the present application are set forth in the following drawings and description. Other features and advantages of the present application will be apparent from the description, drawings and claims.

### BRIEF DESCRIPTION OF THE DRAWINGS

In order to illustrate technical solutions of the embodiments of the present application or the related art more clearly, the drawings that are required in the description of the embodiments will be briefly introduced below. Apparently, the drawings in the following description are merely some embodiments of the present application, and other drawings may be obtained according to these drawings without creative work for a person skilled in the art.

FIG. 1 is a flow chart of the branch instruction processing method according to one or more embodiments of the present application.

FIG. 2 is a first schematic diagram of the branch instruction processing method according to one or more embodiments of the present application.

FIG. 3 is a second schematic diagram of the branch instruction processing method according to one or more embodiments of the present application.

FIG. 4 is a third schematic diagram of the branch instruction processing method according to one or more embodiments of the present application.

FIG. 5 is a flow chart of the branch instruction processing system according to one or more embodiments of the present application.

FIG. 6 is a structural schematic diagram of the branch instruction processing device according to one or more embodiments of the present application.

FIG. 7 is another structural diagram of the branch instruction processing device according to one or more embodiments of the present application.

### DETAILED DESCRIPTION

The technical solutions in the embodiments of the present application will be clearly and completely described with reference to the drawings in the embodiment of the present application below. Apparently, the described embodiments are merely a portion of the embodiments of the present application, but not all the embodiments. Based on the embodiments of the present application, all other embodiments obtained by a person skilled in the art without creative work belong to the protection scope of the present application.

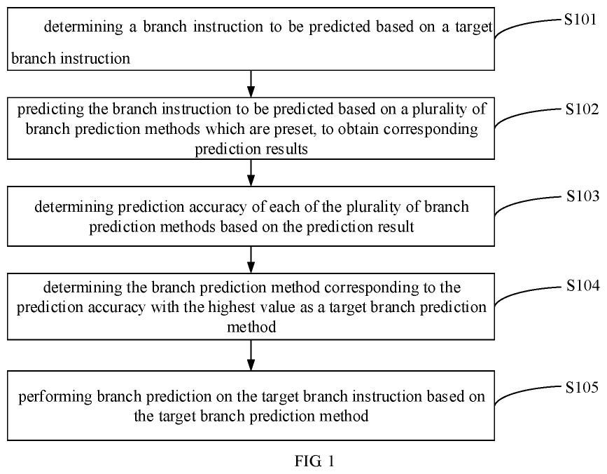

Please refer to FIG. 1, FIG. 1 is a flow chart of the branch instruction processing method according to one or more embodiments of the present application.

The branch instruction processing method provided by the embodiments of the present application is illustrated by taking the application of the method to a computer device as an example. The method may include the following steps:
S101: Determining a branch instruction to be predicted based on a target branch instruction.

In practical application, the branch instruction to be predicted may be determined based on the target branch instruction. The target branch instruction is the branch instruction actually to be processed by the processor, and the branch instruction to be predicted is a branch instruction used to test the accuracy of multiple branch prediction methods subsequently.

It should be noted that, in an application scenario, an instruction having the same architecture as the target branch instruction, but having a short operation cycle may be taken as the branch instruction to be predicted and the like, and the present application is not limited herein. For the convenience of understanding, assuming that the branch instruction processing method provided in the present application is applied to a reduced instruction set computer (RISC)-V processor, the branch instruction to be predicted may be an algorithm/program having the same architecture as a main program running on the RISC-V processor, but having a short operation cycle. It should be pointed out that, the RISC-V referred to in the present application is read as RISC Five, which means the fifth generation reduced instruction processor. It is a brand-new instruction set architecture, and open source may be freely used by any academic institution or business organization, with the advantage of autonomous controllability.
S102: Predicting the branch instruction to be predicted based on a plurality of branch prediction methods which are preset, to obtain corresponding prediction results.

In practical application, after the branch instruction to be predicted is determined based on the target branch instruction, the branch instruction to be predicted may be predicted based on the plurality of branch prediction methods which are preset, and the corresponding prediction results may be obtained, to evaluate the prediction accuracy of each of the branch prediction methods according to the prediction results.
S103: Determining prediction accuracy of each of the branch prediction methods based on the prediction result.
S104: Determining the branch prediction method corresponding to the prediction accuracy with the highest value as a target branch prediction method.
S105: Performing branch prediction on the target branch instruction based on the target branch prediction method.

In practical application, after predicting the branch instruction to be predicted based on the plurality of preset branch prediction methods and obtaining the corresponding prediction results, the prediction accuracy of each of the branch prediction methods may be determined based on the prediction results, and the branch prediction method corresponding to the highest prediction accuracy may be determined as the target branch prediction method. Finally, the target branch instruction is predicted based on the target branch prediction method, to obtain a high accuracy branch prediction result of the target branch instruction, and the processor may accurately process the branch instruction according to the branch prediction result. The branch instruction processing method provided by the present application, determines a branch instruction to be predicted based on the target branch instruction; predicts the branch instruction to be predicted based on the plurality of branch prediction methods which are preset, to obtain the corresponding prediction results; determines the prediction accuracy of each of the branch prediction method based on the prediction results; determines the branch prediction method corresponding to the highest prediction accuracy as the target branch prediction method; based on the target branch prediction method, the target branch instruction is predicted. In the present application, the branch prediction method having the highest prediction accuracy may be selected as the target branch prediction method among the plurality of branch prediction methods, and the target branch instruction is predicted according to the target branch prediction method, so that the accuracy of the prediction result may be ensured, and when the processor processes the branch instruction based on the branch prediction result subsequently, a higher accuracy may be ensured.

It should be noted that, because the present application of the existing RISC-V processor as a dedicated processor is becoming more and more extensive, the problems caused thereby are more and more. For example, the branch prediction mechanism in the RISC-V processor is not suitable for all of application fields. For example, in an A field, the RISC-V processor uses a 1-bit prediction mechanism, which is more efficient. In a B field, the RISC-V processor uses a 2-bit prediction mechanism, which is more efficient, but in the C field, the efficiency of the 2-bit prediction mechanism is higher than the efficiency of the 1-bit prediction mechanism, but limited by the algorithm running on the RISC-V processor, its overall prediction efficiency is generally not high, and no predictor is capable to meet all application scenarios of the RISC-V processor, which makes the processing efficiency of the RISC-V processor lower. When the branch instruction processing method provided by the present application is applied to the RISC-V processor, the accuracy of the branch instruction processing by the RISC-V processor is capable to be ensured, and the processing efficiency of the RISC-V processor is improved thereafter.

In the branch instruction processing method provided by the present application, in order to enrich the final branch prediction result and ensure the accuracy of the branch prediction result, the branch prediction method may include a method for always predicting a jump execution branch instruction, and the branch prediction method may include a method for always predicting a non-jump execution branch instruction.

In the branch instruction processing method provided by the present application, in order to enrich the final branch prediction result and ensure the accuracy of the branch prediction result, the branch prediction method may include a method for determining a current branch prediction result based on a branch prediction state.

In application scenarios, the branch prediction method may include:
when the branch prediction state is a non-jump execution branch instruction of a first-level, the current branch prediction result is not jump; when current branch prediction is verified to be successful, keeping the branch prediction state to be the non-jump execution branch instruction of the first-level; and when the current branch prediction is verified to be failed, adjusting the branch prediction state to be the non-jump execution branch instruction of a second-level;
when the branch prediction state is the non-jump execution branch instruction of the second-level, the current branch prediction result is not jump; and when the current branch prediction is verified to be successful, adjusting the branch prediction state to be the non-jump execution branch instruction of the first-level; and when the current branch prediction is verified to be failed, adjusting the branch prediction state to be a jump execution branch instruction of the second-level;
when the branch prediction state is the jump execution branch instruction of the second-level, the current branch prediction result is jump, when the current branch prediction is verified to be successful, adjusting the branch prediction state to be the jump execution branch instruction of the first-level, and when the current branch prediction is verified to be failed, adjusting the branch prediction state to be the non-jump execution branch instruction of the second-level; and
when the branch prediction state is the jump execution branch instruction of the first-level, the current branch prediction result is jump, when the current branch prediction is verified to be successful, keeping the branch prediction state to be the jump execution branch instruction of the first-level, and when the current branch prediction is verified to be failed, adjusting the current branch prediction state to be the jump execution branch instruction of the second-level;
wherein, an execution probability of the first level is greater than an execution probability of the second level.

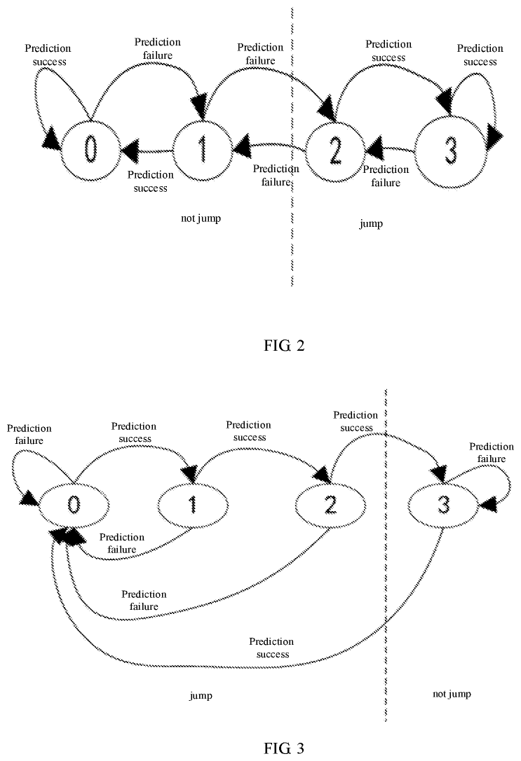

For the convenience of understanding, it is assumed that 0 indicates the non-jump execution branch instruction of the first level, 1 indicates non-jump execution branch instruction of the second level, 2 indicates the jump execution branch instruction of the second level, and 3 indicates the jump execution branch instruction of the first level, jump relationships among the branch prediction results of this branch prediction method are as shown in FIG. 2. Among them, prediction failure represents that the current branch prediction result is wrong, and prediction success represents that the current branch prediction result is correct, it may be seen that, the change of predicted jump/non-jump occurs merely after two consecutive prediction failures occur, so that the moderate jump of the branch instruction is realized.

It should be noted that, every time the branch prediction method of the present embodiment is applied, it is possible to initialize the branch prediction state to be the non-jump execution branch instruction of the first-level, and so on. The present application is not limited herein.

In the branch instruction processing method provided by the present application, in order to enrich the final branch prediction result and ensure the accuracy of the branch prediction result, the branch prediction method may include:
when a cumulative number of prediction results for the branch prediction state representing a jump execution branch instruction is 1, the current branch prediction result is jump, and when the current branch prediction is verified to be successful, adjusting the cumulative number of the prediction results for the branch prediction state representing the jump execution branch instruction to be 2; and when the current branch prediction is verified to be failed, keeping the cumulative number of the prediction results for the branch prediction state representing the jump execution branch instruction to be 1;
when the cumulative number of the prediction results for the branch prediction state representing the jump execution branch instruction is 2, the current branch prediction result is jump; when the current branch prediction is verified to be successful, adjusting the cumulative number of the prediction results for the branch prediction state representing the jump execution branch instruction to be 3; and when the current branch prediction is verified to be failed, adjusting the cumulative number of the prediction results for the branch prediction state representing the jump execution branch instruction to be 1;
when the cumulative number of the prediction results for the branch prediction state representing the jump execution branch instruction is 3, the current branch prediction result is jump; when the current branch prediction is verified to be successful, adjusting the branch prediction state to represent a non-jump execution branch instruction; and when the current branch prediction is verified to be failed, adjusting the cumulative number of the prediction results for the branch prediction state representing the jump execution branch instruction to be 1; and
when the branch prediction state representing the non-jump execution branch instruction. the current branch prediction result is not jump; when the current branch prediction is verified to be successful, adjusting the cumulative number of the prediction results for the branch prediction state representing the jump execution branch instruction to be 1; and when the current branch prediction is verified to be failed, keeping the branch prediction state to represent the non-jump execution branch instruction.

For the convenience of understanding, it is assumed that 0 indicates that the cumulative number of the prediction results of the jump execution branch instruction is 1, 1 indicates that the cumulative number of the prediction results of the jump execution branch instruction is 2, 2 indicates that the cumulative number of the prediction results of the jump execution branch instruction is 3, and 3 indicates the non-jump execute branch instruction, the jump relationships among each of the prediction results of this branch prediction method is as shown in FIG. 3. It may be seen that, merely after three consecutive jump predictions are correct, the next prediction is not jump, and when the prediction fails under the state of not jump, it will return to the state 0 thereafter, merely under the state of not jump, the prediction is successful and remains under the state 3, so that the extremely easy jump prediction of the branch instruction is realized.

It should be noted that, every time the branch prediction method of the present embodiment is applied, the cumulative number of the prediction results for the branch prediction state representing the jump execution branch instruction may be initialized to be 1, and the like. The present application is not limited herein.

In the branch instruction processing method provided by the present application, in order to enrich the final branch prediction result and ensure the accuracy of the branch prediction result. the branch prediction method may include:
when a cumulative number of prediction results for the branch prediction state representing a non-jump execution branch instruction is 1, a current branch prediction result is not jump; when a current branch prediction is verified to be successful, adjusting the cumulative number of the prediction results for the branch prediction state representing the non-jump execution branch instruction to be 2; and when the current branch prediction is verified to be failed. keeping the cumulative number of the prediction results for the branch prediction state representing the non-jump execution branch instruction to be 1;
when the cumulative number of the prediction results for the branch prediction state representing the non-jump execution branch instruction is 2, the current branch prediction result is not jump; when the current branch prediction is verified to be successful, adjusting the cumulative number of the prediction results for the branch prediction state representing the non-jump execution branch instruction to be 3; and when the current branch prediction is verified to be failed, adjusting the cumulative number of the prediction results for the branch prediction state representing the non-jump execution branch instruction to be 1;
when the cumulative number of the prediction results for the branch prediction state representing the non-jump execution branch instruction is 3, the current branch prediction result is not jump; when the current branch prediction is verified to be successful, adjusting the branch prediction state to represent a jump execution branch instruction; and when the current branch prediction is verified to be failed, adjusting the cumulative number of the prediction results for the branch prediction state representing the non-jump execution branch instruction to be 1; and
when the branch prediction state representing the jump execution branch instruction, the current branch prediction result is jump; when the current branch prediction is verified to be failed. keeping the branch prediction state to represent the jump execution branch instruction; and when the current branch prediction is verified to be successful, adjusting the cumulative number of the prediction results for the branch prediction state representing the non-jump execution branch instruction to be 1.

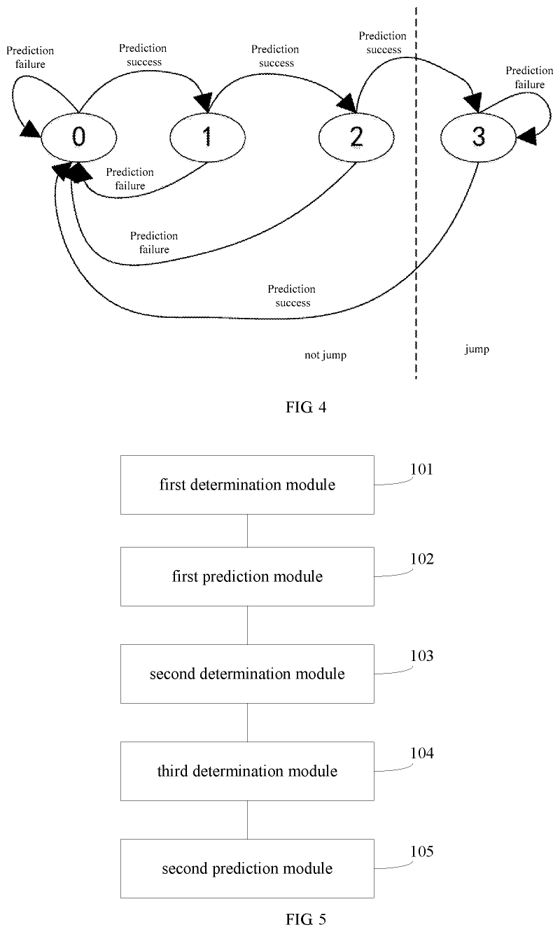

For the convenience of understanding, it is assumed that 0 means that the cumulative number of the prediction results of the non-jump execution branch instruction is 1; 1 indicates that the cumulative number of the prediction results of the non-jump execution branch instruction is 2; 2 indicates that the cumulative number of the prediction results of non-jump execution branch instruction is 3; 3 indicates that jump to execute the branch instruction, the jump relationships among each of the branch prediction results of this branch prediction method is as shown in FIG. 4. It may be seen that, the next prediction is jump merely after three consecutive non-jump predictions are correct, and under the jump state, when the prediction is successful, it will return to the state 0, and merely under the jump state, the prediction fails and remains under the state 3, so that the extremely easy non-jump prediction of the branch instruction is realized.

It should be noted that, every time the branch prediction method of the present embodiment is applied, the cumulative number of the prediction results for the branch prediction state representing non-jump execution branch instruction may be initialized to be 1, and the like. and the present application is not limited herein.

Please refer to FIG. 5, FIG. 5 is a flow chart of the branch instruction processing system according to the embodiments of the present application.

A branch instruction processing system provided by an embodiment of the present application includes:
a first determination module 101, configured for determining a branch instruction to be predicted based on a target branch instruction;
a first prediction module 102, configured for predicting the branch instruction to be predicted based on a plurality of branch prediction methods which are preset, to obtain corresponding prediction results;
a second determination module 103, configured for determining prediction accuracy of each of the plurality of branch prediction methods based on the prediction result;
a third determination module 104, configured for determining the branch prediction method corresponding to the prediction accuracy with the highest value as a target branch prediction method; and
a second prediction module 105, configured for performing branch prediction on the target branch instruction based on the target branch prediction method.

The branch instruction processing system provided by an embodiment of the present application, the branch prediction method includes a method for always predicting a jump execution branch instruction.

The branch instruction processing system provided by an embodiment of the present application, the branch prediction method includes a method for always predicting a non-jump execution branch instruction.

The branch instruction processing system provided by an embodiment of the present application, the branch prediction method includes a method for determining a current branch prediction result based on a branch prediction state.

The branch instruction processing system provided by an embodiment of the present application, the branch prediction method includes;
when the branch prediction state is a non-jump execution branch instruction of a first-level, the current branch prediction result is not jump; when current branch prediction is verified to be successful, keeping the branch prediction state to be the non-jump execution branch instruction of the first-level; and when the current branch prediction is verified to be failed, adjusting the branch prediction state to be the non-jump execution branch instruction of a second-level;
when the branch prediction state is the non-jump execution branch instruction of the second-level, the current branch prediction result is not jump; and when the current branch prediction is verified to be successful, adjusting the branch prediction state to be the non-jump execution branch instruction of the first-level; and when the current branch prediction is verified to be failed, adjusting the branch prediction state to be a jump execution branch instruction of the second-level;
when the branch prediction state is the jump execution branch instruction of the second-level, the current branch prediction result is jump, when the current branch prediction is verified to be successful, adjusting the branch prediction state to be the jump execution branch instruction of the first-level, and when the current branch prediction is verified to be failed, adjusting the branch prediction state to be the non-jump execution branch instruction of the second-level; and
when the branch prediction state is the jump execution branch instruction of the first-level, the current branch prediction result is jump, when the current branch prediction is verified to be successful, keeping the branch prediction state to be the jump execution branch instruction of the first-level, and when the current branch prediction is verified to be failed, adjusting the current branch prediction state to be the jump execution branch instruction of the second-level;
among them, an execution probability of the first level is greater than an execution probability of the second level.

The branch instruction processing system provided by an embodiment of the present application, the branch prediction method includes:
when a cumulative number of prediction results for the branch prediction state representing a jump execution branch instruction is 1, the current branch prediction result is jump, and when the current branch prediction is verified to be successful, adjusting the cumulative number of the prediction results for the branch prediction state representing the jump execution branch instruction to be 2; and when the current branch prediction is verified to be failed, keeping the cumulative number of the prediction results for the branch prediction state representing the jump execution branch instruction to be 1;
when the cumulative number of the prediction results for the branch prediction state representing the jump execution branch instruction is 2, the current branch prediction result is jump; when the current branch prediction is verified to be successful, adjusting the cumulative number of the prediction results for the branch prediction state to represent the jump execution branch instruction to be 3; and when the current branch prediction is verified to be failed, adjusting the cumulative number of the prediction results for the branch prediction state representing the jump execution branch instruction to be 1;
when the cumulative number of the prediction results for the branch prediction state representing the jump execution branch instruction is 3, the current branch prediction result is jump; when the current branch prediction is verified to be successful, adjusting the branch prediction state representing a non-jump execution branch instruction; and when the current branch prediction is verified to be failed, adjusting the cumulative number of the prediction results for the branch prediction state representing the jump execution branch instruction to be 1; and
when the branch prediction state representing the non-jump execution branch instruction, the current branch prediction result is not jump; when the current branch prediction is verified to be successful, adjusting the cumulative number of the prediction results for the branch prediction state representing the jump execution branch instruction to be 1 and when the current branch prediction is verified to be failed, keeping the branch prediction state to represent the non-jump execution branch instruction.

The branch instruction processing system provided by an embodiment of the present application, the branch prediction method includes:
when a cumulative number of prediction results for the branch prediction state representing a non-jump execution branch instruction is 1, a current branch prediction result is not jump; when a current branch prediction is verified to be successful, adjusting the cumulative number of the prediction results for the branch prediction state representing the non-jump execution branch instruction to be 2; and when the current branch prediction is verified to be failed. keeping the cumulative number of the prediction results for the branch prediction state representing the non-jump execution branch instruction to be 1;
when the cumulative number of the prediction results for the branch prediction state representing the non-jump execution branch instruction is 2, the current branch prediction result is not jump when the current branch prediction is verified to be successful, adjusting the cumulative number of the prediction results for the branch prediction state representing the non-jump execution branch instruction to be 3; and when the current branch prediction is verified to be failed, adjusting the cumulative number of the prediction results for the branch prediction state representing the non-jump execution branch instruction to be 1;
when the cumulative number of the prediction results for the branch prediction state representing the non-jump execution branch instruction is 3, the current branch prediction result is not jump; when the current branch prediction is verified to be successful, adjusting the branch prediction state to represent a jump execution branch instruction; and when the current branch prediction is verified to be failed, adjusting the cumulative number of the prediction results for the branch prediction state representing the non-jump execution branch instruction to be 1; and
when the branch prediction state representing the jump execution branch instruction, the current branch prediction result is jump; when the current branch prediction is verified to be failed, keeping the branch prediction state to represent the jump execution branch instruction; and when the current branch prediction is verified to be successful, adjusting the cumulative number of the prediction results for the branch prediction state representing the non-jump execution branch instruction to be 1.

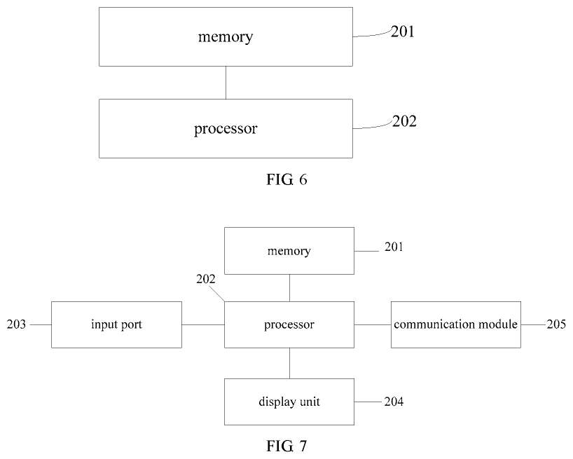

The present application further provides a branch instruction processing device and a computer-readable storage medium, both the branch instruction processing device and the computer-readable storage medium have corresponding effects of the branch instruction processing method provided by the embodiment of the present application. Please refer to FIG. 6, which is a structural schematic diagram of the branch instruction processing device provided by an embodiment of the present application.

A branch instruction processing device provided by an embodiment of the present application may be a computer device, and the computer device may be a terminal or a server. This branch instruction processing device includes a memory 201 and one or more processors 202, and a computer-readable instruction is stored in the memory 201, the computer-readable instruction. when executed by the processors 202, the steps of the branch instruction processing method of any one of the above-mentioned embodiments may be realized.

Please refer to FIG. 7, another branch instruction processing device provided by an embodiment of the present application may further include an input port 203 connected to the processor 202, configured for transmitting commands input from the outside to the processor 202; a display unit 204 connected to the processor 202, configured for displaying the processing result of the processor 202 to the outside; a communication module 205 connected to the processor 202, configured for realizing the communication between the branch instruction processing device and the outside. The display unit 204 may be a display panel, a laser scanning displayer, and the like. Communication modes adopted by the communication module 205 include, but are not limited to, mobile high-definition link technology (HML), universal serial bus (USB), high-definition multimedia interface (HDMI), wireless connection for example wireless fidelity technology (WiFi), Bluetooth communication technology, low-power Bluetooth communication technology and communication technology based on IEEE802.11s.

An embodiment of the present application provides a non-transitory computer-readable storage medium in which a computer-readable instruction is stored, the computer-readable instruction, when executed by one or more processors, the steps of the branch instruction processing method of any one of the above-mentioned embodiments may be realized.

It should also be noted that, in the resent application, relational terms for example first and second are merely used to distinguish one entity or operation from another entity or operation, and do not necessarily require or imply that any such actual relationship or order between these entities or operations exist. Moreover, the terms “comprise”, “include” or any other variation thereof are intended to cover non-exclusive inclusion, so that a process, a method, a product or an apparatus including a series of elements includes not only those elements, but also other elements not explicitly listed or elements inherent to such process, method, product or apparatus. Without further restrictions, an element defined by the phrase “include one” does not exclude the existence of other identical elements in the process, method, product or apparatus including the element.

A person skilled in the art may understand that, all or portions of the processes in the method for realizing the above-mentioned embodiments may be completed by instructing related hardware through computer-readable instructions, the computer-readable instruction may be stored in a non-transitory computer-readable storage medium, and when the computer-readable instruction is executed, the processes of the above-mentioned methods may be included. Among them, any reference to memory, storage, database or other media used in the embodiments provided in the present application may include non-transitory and/or transitory memory. The non-transitory memory may include a read-only memory (ROM), a programmable ROM (PROM), an electrically programmable ROM (EPROM), an electrically erasable programmable ROM (EEPROM) or a flash memory. The transitory memory may include a random access memory (RAM) or an external cache memory. By way of illustration and not limitation, RAM is available in various forms, for example static RAM (SRAM), dynamic RAM (DRAM), synchronous DRAM (SDRAM), double data rate SDRAM (DDRSDRAM), enhanced SDRAM (ESDRAM), synchronous link DRAM (SLDRAM), memory bus (Rambus) direct RAM (RDRAM), Direct memory bus dynamic RAM (DRDRAM) and memory bus dynamic RAM (RDRAM), and the like.

The technical features of the above-mentioned embodiments may be combined at will. In order to make the description concise, not all possible combinations of the technical features in the above-mentioned embodiments are described. However, as long as no contradiction exists between the combinations of those technical features, they should be considered as the scope recorded in the present description.

The above-mentioned embodiments merely express several implementations of the present application, and their descriptions are more specific and detailed, but they cannot be understood as limiting the scope of the present application. It should be pointed out that, for a person skilled in the art, without departing from the concept of the present application, some modifications and improvements may be made, which are within the protection scope of the present application. Consequently, the protection scope of the present application shall be subject to the appended claims.

1. A branch instruction processing method, comprising:
determining a branch instruction to be predicted based on a target branch instruction;
predicting the branch instruction to be predicted based on a plurality of branch prediction methods which are preset, to obtain corresponding prediction results;
determining prediction accuracy of each of the plurality of branch prediction methods based on the prediction result;
determining the branch prediction method corresponding to the prediction accuracy with the highest value as a target branch prediction method; and
performing branch prediction on the target branch instruction based on the target branch prediction method.

2. The method according to claim 1, wherein the branch prediction method comprises a method for always predicting a jump execution branch instruction.

3. The method according to claim 1, wherein the branch prediction method comprises a method for always predicting a non-jump execution branch instruction.

4. The method according to claim 1, wherein the branch prediction method comprises a method for determining a current branch prediction result based on a branch prediction state.

5. The method according to claim 4, wherein the branch prediction method comprises:
when the branch prediction state is a non-jump execution branch instruction of a first-level, the current branch prediction result is not jump; when current branch prediction is verified to be successful, keeping the branch prediction state to be the non-jump execution branch instruction of the first-level; and when the current branch prediction is verified to be failed, adjusting the branch prediction state to be the non-jump execution branch instruction of a second-level;
when the branch prediction state is the non-jump execution branch instruction of the second-level, the current branch prediction result is not jump; and when the current branch prediction is verified to be successful, adjusting the branch prediction state to be the non-jump execution branch instruction of the first-level; and when the current branch prediction is verified to be failed, adjusting the branch prediction state to be a jump execution branch instruction of the second-level;
when the branch prediction state is the jump execution branch instruction of the second-level, the current branch prediction result is jump, when the current branch prediction is verified to be successful, adjusting the branch prediction state to be the jump execution branch instruction of the first-level, and when the current branch prediction is verified to be failed, adjusting the branch prediction state to be the non-jump execution branch instruction of the second-level; and
when the branch prediction state is the jump execution branch instruction of the first-level, the current branch prediction result is jump, when the current branch prediction is verified to be successful, keeping the branch prediction state to be the jump execution branch instruction of the first-level, and when the current branch prediction is verified to be failed, adjusting the current branch prediction state to be the jump execution branch instruction of the second-level;
wherein, an execution probability of the first level is greater than an execution probability of the second level.

6. The method according to claim 4, wherein the branch prediction method comprises:
when a cumulative number of prediction results for the branch prediction state representing a jump execution branch instruction is 1, the current branch prediction result is jump, and when the current branch prediction is verified to be successful, adjusting the cumulative number of the prediction results for the branch prediction state representing the jump execution branch instruction to be 2; and when the current branch prediction is verified to be failed, keeping the cumulative number of the prediction results for the branch prediction state representing the jump execution branch instruction to be 1;
when the cumulative number of the prediction results for the branch prediction state representing the jump execution branch instruction is 2, the current branch prediction result is jump; when the current branch prediction is verified to be successful, adjusting the cumulative number of the prediction results for the branch prediction state representing the jump execution branch instruction to be 3; and when the current branch prediction is verified to be failed, adjusting the cumulative number of the prediction results for the branch prediction state representing the jump execution branch instruction to be 1;
when the cumulative number of the prediction results for the branch prediction state representing the jump execution branch instruction is 3, the current branch prediction result is jump; when the current branch prediction is verified to be successful, adjusting the branch prediction state to represent a non-jump execution branch instruction; and when the current branch prediction is verified to be failed, adjusting the cumulative number of the prediction results for the branch prediction state representing the jump execution branch instruction to be 1; and
when the branch prediction state representing the non-jump execution branch instruction, the current branch prediction result is not jump; when the current branch prediction is verified to be successful, adjusting the cumulative number of the prediction results for the branch prediction state representing the jump execution branch instruction to be 1; and when the current branch prediction is verified to be failed, keeping the branch prediction state to represent the non-jump execution branch instruction.

7. The method according to claim 1, wherein the branch prediction method comprises:
when a cumulative number of prediction results for the branch prediction state representing a non-jump execution branch instruction is 1, a current branch prediction result is not jump; when a current branch prediction is verified to be successful, adjusting the cumulative number of the prediction results for the branch prediction state representing the non-jump execution branch instruction to be 2; and when the current branch prediction is verified to be failed, keeping the cumulative number of the prediction results for the branch prediction state representing the non-jump execution branch instruction to be 1;
when the cumulative number of the prediction results for the branch prediction state representing the non-jump execution branch instruction is 2, the current branch prediction result is not jump; when the current branch prediction is verified to be successful, adjusting the cumulative number of the prediction results for the branch prediction state representing the non-jump execution branch instruction to be 3; and when the current branch prediction is verified to be failed, adjusting the cumulative number of the prediction results for the branch prediction state representing the non-jump execution branch instruction to be 1;
when the cumulative number of the prediction results for the branch prediction state representing the non-jump execution branch instruction is 3, the current branch prediction result is not jump; when the current branch prediction is verified to be successful, adjusting the branch prediction state to represent a jump execution branch instruction; and when the current branch prediction is verified to be failed, adjusting the cumulative number of the prediction results for the branch prediction state representing the non-jump execution branch instruction to be 1; and
when the branch prediction state representing the jump execution branch instruction, the current branch prediction result is jump; when the current branch prediction is verified to be failed, keeping the branch prediction state to represent the jump execution branch instruction; and when the current branch prediction is verified to be successful, adjusting the cumulative number of the prediction results for the branch prediction state representing the non-jump execution branch instruction to be 1.

8. (canceled)

9. A branch instruction processing device, comprising a memory and one or more processors, wherein a computer-readable instruction is stored in the memory, and when executed by the one or more processors, the computer-readable instruction makes the one or more processors execute operations comprising:
determining a branch instruction to be predicted based on a target branch instruction;
predicting the branch instruction to be predicted based on a plurality of branch prediction methods which are preset, to obtain corresponding prediction results;
determining prediction accuracy of each of the plurality of branch prediction methods based on the prediction result;
determining the branch prediction method corresponding to the prediction accuracy with the highest value as a target branch prediction method; and
performing branch prediction on the target branch instruction based on the target branch prediction method.

10. One or more non-transitory computer-readable storage media storing a computer-readable instruction, wherein the computer-readable instruction, when executed by one or more processors, makes the one or more processors execute operations comprising:
determining a branch instruction to be predicted based on a target branch instruction;
predicting the branch instruction to be predicted based on a plurality of branch prediction methods which are preset, to obtain corresponding prediction results;
determining prediction accuracy of each of the plurality of branch prediction methods based on the prediction result;
determining the branch prediction method corresponding to the prediction accuracy with the highest value as a target branch prediction method; and
performing branch prediction on the target branch instruction based on the target branch prediction method.

11. The method according to claim 1, wherein the target branch instruction is a branch instruction actually to be processed by a processor.

12. The method according to claim 1, wherein the branch instruction to be predicted is a branch instruction used to test the accuracy of the plurality of branch prediction methods subsequently.

13. The method according to claim 1, wherein an instruction having the same architecture as the target branch instruction and a short operation cycle is taken as the branch instruction to be predicted.

14. The method according to claim 13, wherein when the branch instruction processing method is applied to a reduced instruction set computer (RISC)-V processor, the branch instruction to be predicted is an algorithm or a program having the same architecture as a main program running on the RISC-V processor and a short operation cycle.

15. The method according to claim 5, wherein when the current branch prediction is verified to be failed, it represents that the current branch prediction result is wrong, and when the current branch prediction is verified to be successful, it represents that the current branch prediction result is correct.

16. The method according to claim 6, wherein every time the branch prediction method is applied, the cumulative number of the prediction results for the branch prediction state representing the jump execution branch instruction is initialized to be 1.

17. The method according to claim 7, wherein every time the branch prediction method is applied, the cumulative number of the prediction results for the branch prediction state representing non-jump execution branch instruction is initialized to be 1.

18. The device according to claim 9, wherein the device further includes:
an input port connected to the processor, configured for transmitting commands input from the outside to the processor;
a display unit connected to the processor, configured for displaying the processing result of the processor to the outside; and
a communication module connected to the processor, configured for realizing the communication between the branch instruction processing device and the outside.

19. The device according to claim 18, wherein the display unit is a display panel or a laser scanning displayer.

20. The device according to claim 18, wherein communication modes adopted by the communication module comprise mobile high-definition link technology (HML), universal serial bus (USB), high-definition multimedia interface (HDMI) and wireless connection.

21. The device according to claim 9, wherein the operations comprises an operation for always predicting a jump execution branch instruction.
